(19) United States
(12) Patent Application Publication
(10) Pub. No.: US 2012/0233351 A1
(43) Pub. Date: Sep. 13, 2012

(54) Method of directing network traffic

(76) Inventor: Richard Gorgens, Plantation, FL (US)

(21) Appl. No.: 13/385,663

(22) Filed: Feb. 29, 2012

Related U.S. Application Data
(60) Provisional application No. 61/451,643, filed on Mar. 11, 2011.

(51) Int. Cl. G06F 15/16

(52) U.S. Cl. 709/245

(57) ABSTRACT

A method of directing network traffic wherein a router IP address is registered and associated with at least one website address. At a user device, a domain name request is made via that router. This request is directed to a virtual network server configured to ascertain the registered website address associated with the router IP address. The user device is then automatically redirected to request the registered website address. The user device is then served one or more web pages associated with that website address.

### RELATED APPLICATIONS

This application claims benefit of and priority to U.S. Provisional Application Ser. No. 61/451,643 filed Mar. 11, 2011 under 35 U.S.C. §§119, 120, 363, 365, and 37 C.F.R. §1.55 and §1.78 and incorporated herein by this reference.

### FIELD OF THE INVENTION

This invention relates to the internet and web pages.

### BACKGROUND OF THE INVENTION

The application protocol underlying the World Wide Web, one of the most commonly used services on the internet, is the hyper text transfer protocol or HTTP. HTTP is the protocol that web browsers and web servers use to communicate with each other over the internet. This application level protocol sits on top of the transmission control protocol (TCP) layer of the internet protocol stack and is used by specific applications (web browsers and web servers) to talk to one another.

Typically, clients (web browsers) send requests to web servers for web elements such as web pages and images. After the request is serviced by a server, the connection between the client and the web server is disconnected. A new connection must be made for each request. Most protocols are connection oriented. This means that two computers communicating with each other must keep the connection open over the internet. HTTP however does not. Before an HTTP request can be made by a client, a new connection must be made to the server.

When a request or website address or uniform resource locator is typed into a web browser, the browser first connects to one or more domain name servers and to determine the corresponding IP address for the web server. The web browser then connects to the web server and sends an HTTP request (via the internet protocol stack) for the desired web page. The web server receives the request and checks for the desired page. The web server sends the desired page, the web browser receives it and the connection is closed. The browser then parses through the page and looks for other page elements to complete the web page. For each element needed, the browser makes additional connections and HTTP requests to the server for each element. When the browser has finished loading all the images, applets, and the like, the page will be completely loaded in the browser window.

The internet has been used to provide a user or client or mobile device (e.g. smart phone) with various web pages (e.g. coupons, offers, information, and the like) as a function of the location of the user typically by employing GPS data to pinpoint the location of the user. See U.S. Pat. No. 7,848,765 incorporated herein by this reference.

GPS data is not always available (indoors, for example) and some user devices are not GPS enabled.

### SUMMARY OF THE INVENTION I

The invention, in one particular embodiment, is a new method of and system for redirecting network traffic to provide a user with coupons, offers, information, and the like based not on GPS data but on the router IP address currently servicing the user. The user bookmarks a pre-established domain name or host.domain name. A registrant such as a merchant registers a router IP address. A user enters a registrant's establishment and uses its Wi-Fi service. Information, coupons, offers, and the like particular to that establishment are then automatically provided to the user. Later, when the user enters a second establishment, information, coupons, offers, and the like particular to that establishment are then automatically provided to the user. And, the user need only activate the one pre-established bookmark to view the websites of different establishments automatically depending on which establishment the user is visiting.

Featured is a method of directing network traffic comprising registering a router IP address and associating it with at least one website address (e.g., http://merchantl.com/deals). At a user device, a preestablished domain name like Pip.co is requested via the router. This request is redirected to a virtual network server configured to ascertain the website address (http://merchantl.com/deals) associated with the router IP address (2.3.4.5). The user device is redirected to request the website address http://merchantl.com/deals and the user device is served one or more web pages associated with that website address.

In some embodiments, directing the request includes first directing the request to a domain name server of the virtual network server and then redirecting the user device to a web server of the virtual network server configured to receive a web request. The web server then redirects the user device to request the website address to prevent caching.

The user device maybe served one or more default web pages if there is no website address associated with the router IP address. Preferably, the domain name x.pip.co is bookmarked on the user device.

Also featured is a method directing network traffic comprising registering a router IP address and associating it with at least one web site address, directing a pre-established user device request via the router to a virtual network server configured to ascertain the web site address associated with the router IP address and automatically redirecting the user device to request the website address to serve the user device one or more web pages associated with the web site address. The preferred method further includes serving the user device one or more web pages associated with the web site address.

A network traffic redirection system in accordance with examples of the invention include a virtual network server including a registration website configured to allow a registrant to register at least one website address associated with a router IP address. The virtual network server further includes a web server and a domain name server. The domain server is configured to automatically receive a pre-established domain name request from a user device connected to the router and is configured to redirect the user device request to the web server. The web server is configured to automatically receive the redirected user device request and redirect the user device request to the registered web site.

Registration website may be configured to allow a user to bookmark the pre-established domain name on the user device.

One network traffic redirecting system may include a registration site configured to register a router external IP address and to associate it with at least one website address, a user device configured to request a domain name via the router; and a virtual network server configured to ascertain the website address associated with the router website IP address and redirect the user device to request the website address to serve the user device one or more web pages associated with the web site address.

The virtual network server may include a domain name server configured to receive the user device request. The domain name server may be configured to redirect the user device request to a web server of the virtual network server and to redirect the user device to request the web site address to prevent caching.

The subject invention, however, in other embodiments, need not achieve all these objectives and the claims hereof should not be limited to structures or methods capable of achieving these objectives.

### BRIEF DESCRIPTION OF THE SEVERAL VIEWS OF THE DRAWINGS

Other objects, features and advantages will occur to those skilled in the art from the following description of a preferred embodiment and the accompanying drawings, in which:

FIG. 1 is a block diagram showing several of the primary components associated with a registration subsystem in accordance with an example of the invention;

FIG. 2 is a flow chart depicting the typical steps carried out by the web server component of the registration subsystem show in FIG. 1 in order to register a merchant with the system of the invention;

FIG. 3A-3F are block diagrams depicting, in one particular example, the primary components associated with and the overall flow of information between a user and a virtual network server in accordance with the inventive method of directing network traffic described herein; and

FIG. 4 of the flow chart depicting the primary steps associated with a method of directing network traffic in accordance with examples of the invention.

### DETAILED DESCRIPTION OF THE INVENTION

Aside from the preferred embodiment or embodiments disclosed below, this invention is capable of other embodiments and of being practiced or being carried out in various ways. Thus, it is to be understood that the invention is not limited in its application to the details of construction and the arrangements of components set forth in the following description or illustrated in the drawings. If only one embodiment is described herein, the claims hereof are not to be limited to that embodiment. Moreover, the claims hereof are not to be read restrictively unless there is clear and convincing evidence manifesting a certain exclusion, restriction, or disclaimer.

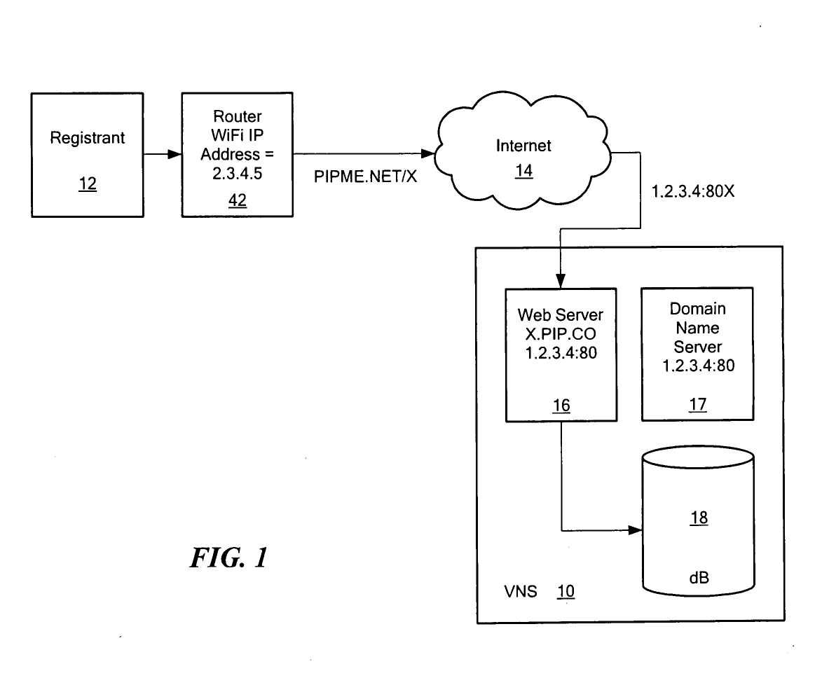

FIG. 1 depicts how a registrant, for example an establishment such as a shopping mall or a restaurant, registers with virtual network server 10 in order for users of mobile devices (e.g., cell phones, portable computers, and the like) to receive a web page or pages specified by the establishment when a user connects to the establishment's Wi-Fi router or “hotspot.”

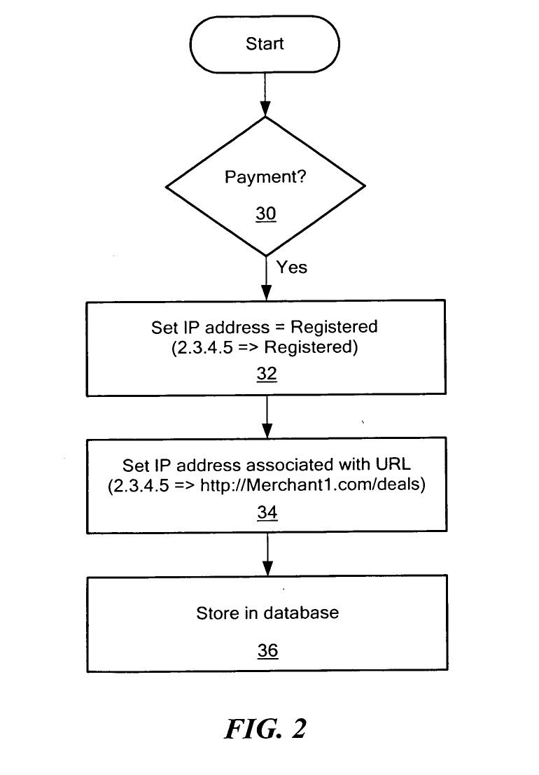

Registrant 12, via a browser, requests the registration website (here, in this example, PIPME.net/x) and is directed via a network such as the internet 14 to the IP address 1.2.3.4.80x of web server 16. One or more web pages there are configured to receive payment, step 30, FIG. 2, automatically extract and register the registrant's Wi-Fi router IP address (here, 2.3.4.5), step 32, and store in data base 18, FIG. 1 one or more web site addresses (here http://merchant1.com/deals) associated with the registrant's establishment or location (here associated with the registrant's Wi-Fi′ router address 2.3.4.5), steps 34 and 36, FIG. 2.

Numerous registrations are possible and a given registrant can register many different Wi-Fi IP addresses as would be the case with franchisees or a chain of merchants with many locations each served by a different Wi-Fi router

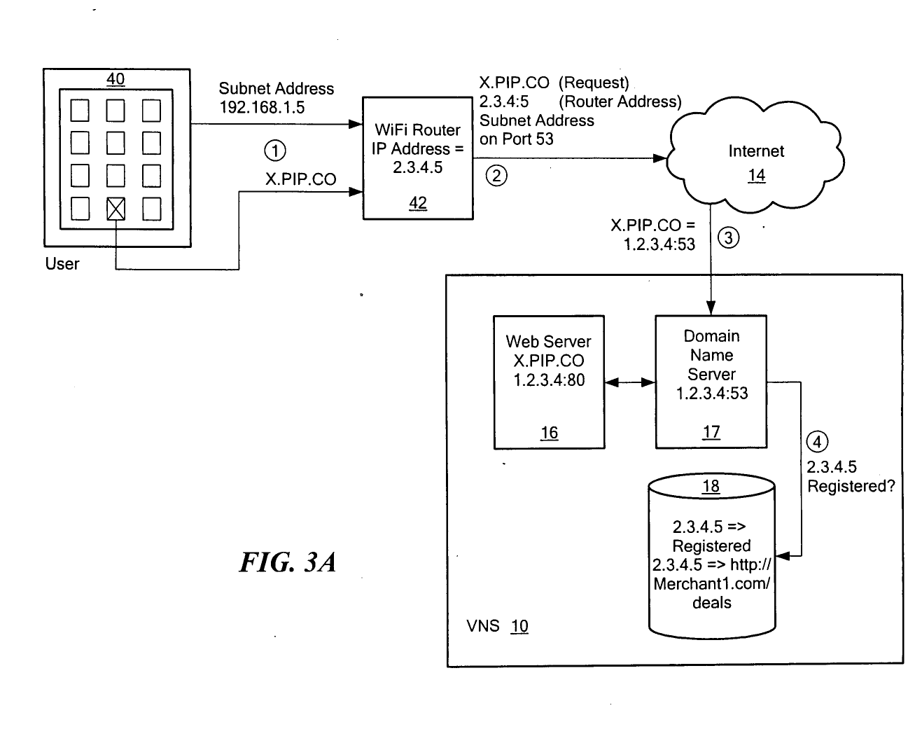

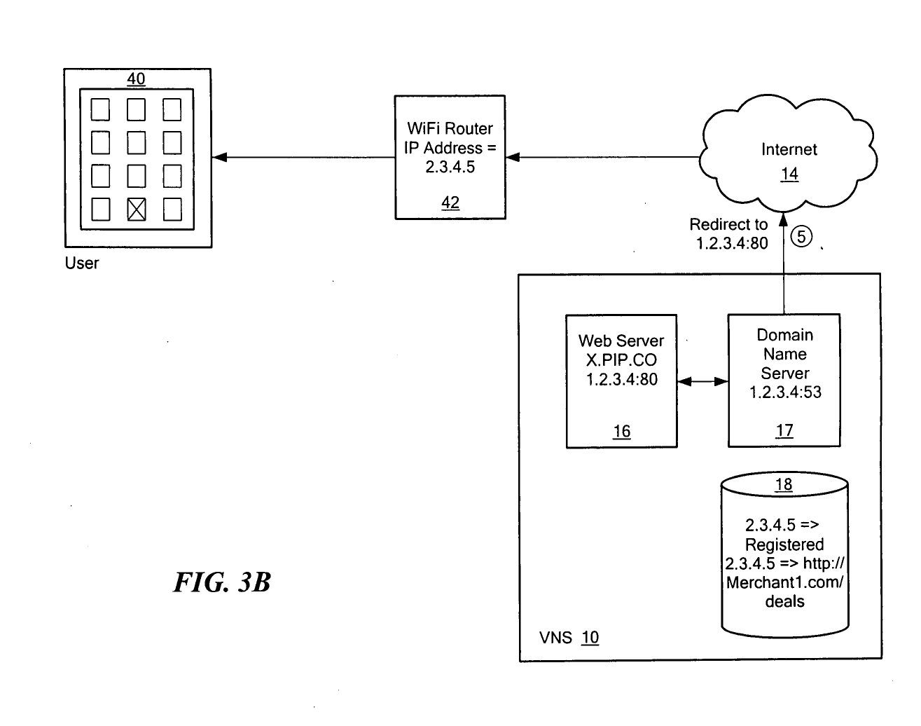

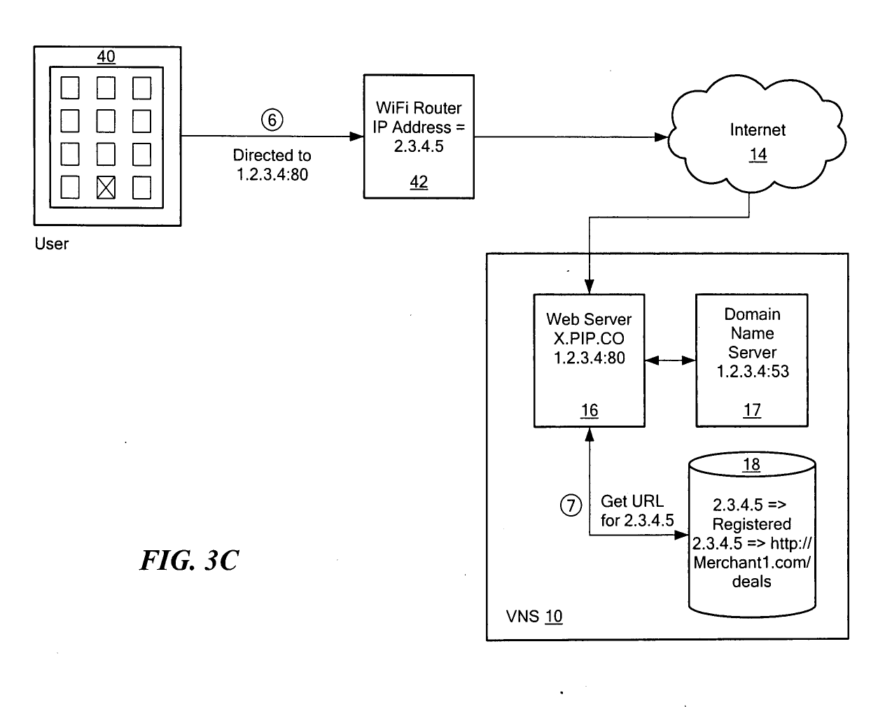

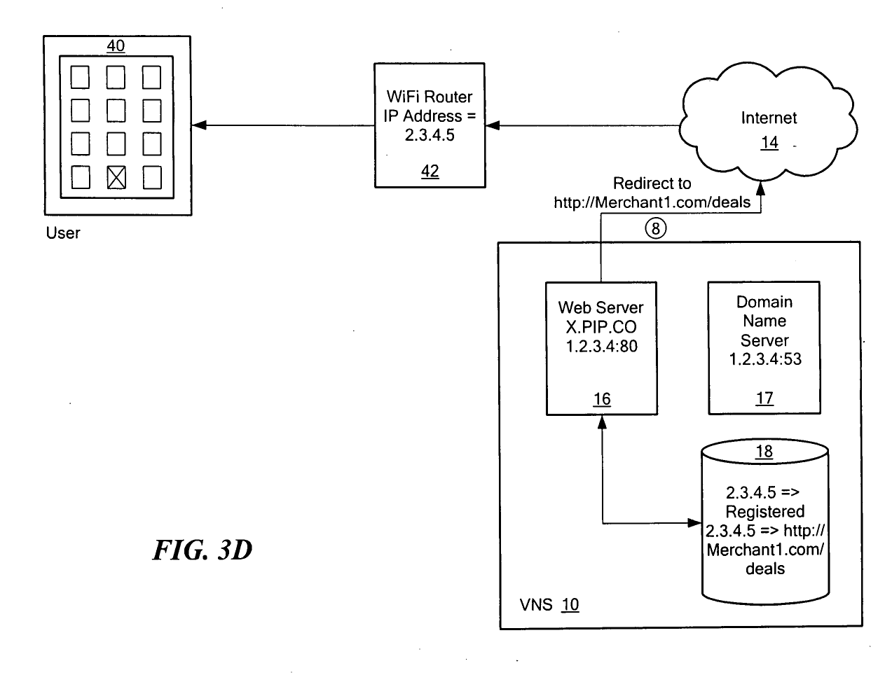

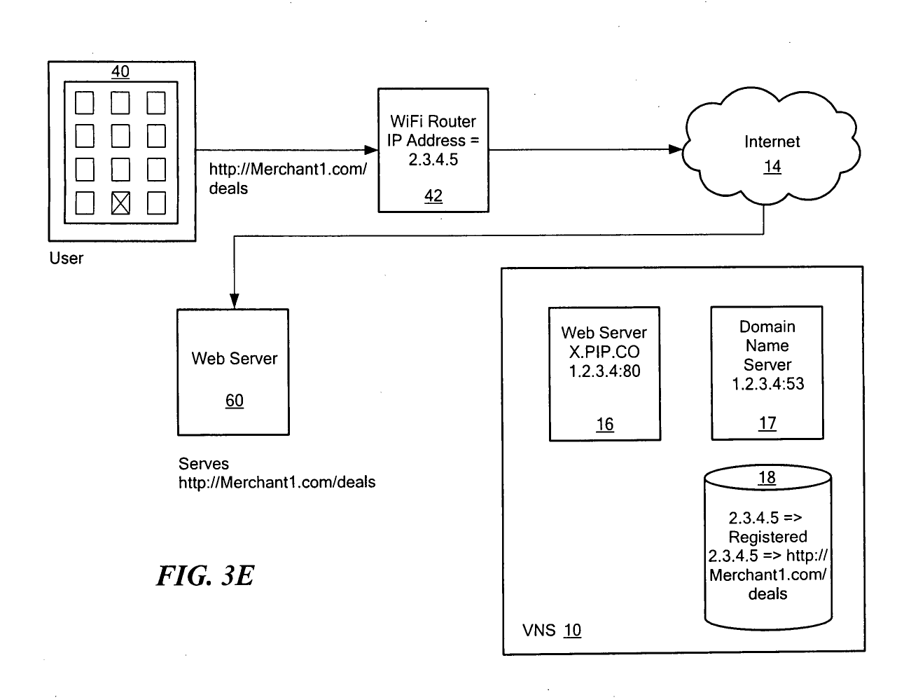

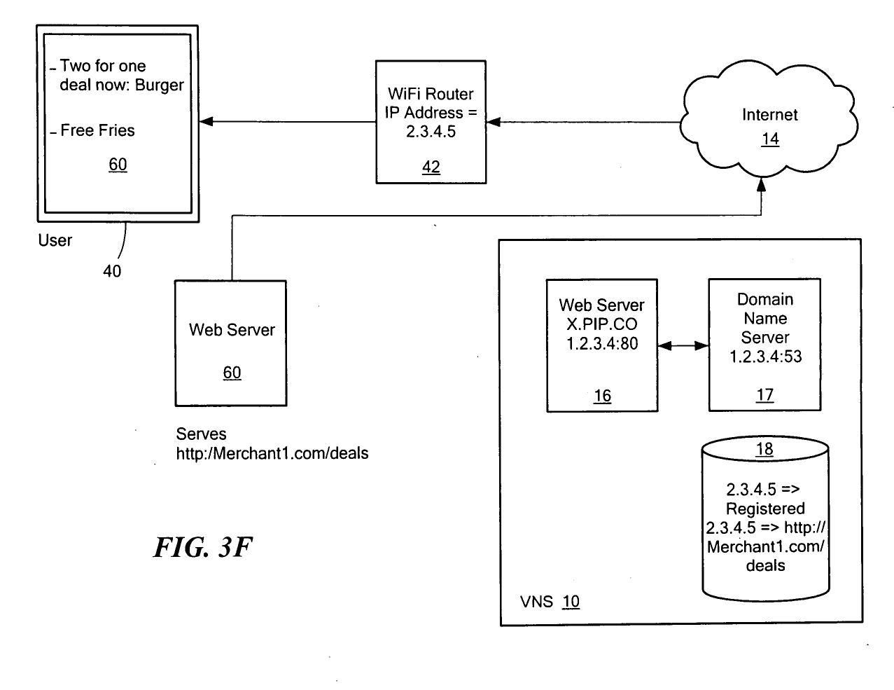

A user (e.g., a customer or a potential customer) then uses mobile device 40, FIG. 3A (e.g., a smart phone or the like) to connect to the Wi-Fi router 42 present at a registrant's place of business. In this particular example, this merchant is identified a merchant #1 and has established a web site offering customers or potential customers deals (coupons, sales, or the like at http://merchant1.com/deals).

The user device has a pre-established domain name (here x.pip.co) bookmarked or the user employs a browser to request the pre-established domain name which could be a fully qualified domain name, or other domain name (e.g., pip.co). On an Apple iPhone, the bookmark would appear as an icon on the screen activated by touching it.

In any case, the user requests a domain name which the Wi-Fi router 42 receives and forwards (e.g., on port 53) to the internet along with the router IP address (2.3.4:5) to identify the originating router. Also, router 42 is configured provide a subnet address (e.g., 192.168.1.5) to user devise 40 in order to route data received by the router from the internet to the correct user device. The subnet address is also forwarded by the router to the internet along with the user's request and the router IP address.

The standard domain name system is a network based on the UDP transfer protocol on port 53. If one domain name server doesn't know how to translate a particulate domain name, it asks another one, and so on until the correct IP address is returned. The domain name system distributes the responsibility of assigning domain names and mapping those names to IP addresses by designating authoritative named servers for each domain. Authoritative named servers are assigned to be responsible for their particular domains and can, in turn, assign other authoritative name servers for their subdomains. This mechanism renders these domain name system distributed and fault tolerant and eliminates the need for a single central register to be continually consulted and updated.

Thus, when the user's browser makes the pre-established domain name request x.pip.co domain name server 17, FIG. 3A is authoritative for the pip.co domain and therefore any domain name server request for x.pip.co ultimately ends up at domain name server 17. Domain name server 17 has the IP address 1.2.3.4:53, in this example.

In this way, the user's request is ultimately directed via the interne to domain name server 17 and domain name severer 17 is configured to ascertain whether the router IP address submitted along with the user's request is registered and if so which website addresses the registrant desires its customers to view.

In this example the registrant desires the user to be automatically redirected to the website http://merchantl.com/deals so the user will receive special deals after entering the registrants' place of business and connecting to its Wi-Fi router.

If the Wi-Fi router address (in this example 2.3.4.5) is not registered, virtual network server 10 is typically configured to serve the user device with one or more default web pages (e.g., offers, for example, different coupons, deals, specials, and information not typically unique to a given registrant).

When a match is found, however, domain name sever 17, FIG. 3B forwards a redirection (here 1.2.3.4:80), the IP address of primitive web server 16 (which is received at user device 40 via internet 14 and router 42). The browser of user devise 40, FIG. 3C, then requests a redirected IP address (1.2.3.4:80) and this request is received by web server 16 via router 42 and internet 14. Web server 16, in turn, is configured to retrieve, from database 18, the URL corresponding to the router address, here http://merchant1.com/deals. Web server 16 then issues a redirection, FIG. 3D forwarded to user device 40 via internet 14 and Wi-Fi router 42 in order to redirect the user device to this particular website (i.e., the website of the merchant or in the example, http://merchantl.com/deals).

In FIG. 3E, the user device browser now requests the webpage(s) associated with the registered website address and this request is forwarded by the router 42 and internet 14 to web server 60 which, as depicted in FIG. 3F serves (via the internet and router 42) the user device browser with website page(s) which are displayed on user device 40 as shown at 60.

In this way, the customer or potential customer receives deals and the like from this merchant upon connecting with the merchant's router (or hot spot) by making a request, typically via a bookmark. At a different merchant, the same request is made and now, automatically, that merchant's webpage(s) are served to the user. Interacting with various merchants' websites is thus easier and faster in order to receive deals, directions, and other information.

The redirection from domain name server 17, FIG. 3B (IP address 1.2.3.4:53) to web server 16, FIG. 3C (IP address 1.2.3.4:80) is desirable in one preferred embodiment to avoid using a cached URL at the user device. When mobile user at a hot spot enters the website based on the pre-established request x.pip.co via a browser, the browser is redirected to a target site selected by virtual network server 10 based on the user's router external IP. It is desirable for a user to bookmark the URL http://x.pip.co in the user's browser. One potential problem occurs when the browser is redirected to the target site and it cannot be bookmarked since the user's browser is never stopped at the URL http://x.pip.co. A solution is a cookie (xpip) added by the site x.pip.co at the site's root “/” path. If the user enters a site http://x.pip.co/<pathtail> where <pathtail> is non-empty string, the mime type is checked of the file requested in that <pathtail>. If the mime type is text/html, the cookie xpip is cleared and the browser is redirected to the root “/” of the current site. It then stops at the http://x.pip.co site and can instruct the user to add a bookmark and then hit a continue button.

If the mime type is anything else, the file requested is returned and no change is made to the cookie state. This is most useful for any icon files e.g., favicon.co that would appear on the x.pip.co bookmark link. If the user enters the root http://x.pip.co/ without the cookie “xpip”, the cookie “xpip” is added and the file returned/default.htm to the browser.

This file instructs the user device to set a bookmark and to click “Continue” when done. Since this file may load images such as favicon.ico referenced above, the browser request would come via a path and the VNS 10 will service the file without redirection or change in the cookie state.

Hence, the image and other non-html files pulled in by this /default.html will from here on come in with the cookie, but they may also have a tail (e.g., the image file name e.g., favicon.ico) and will service those files without redirect or resetting the cookie. The “Continue” link in default.htm redirects browser to the “/” path of the current site. When user has added the bookmark as instructed and clicked “Continue”, the link for continue is “/” hence the user will enter the site “http://x.pip.co/” with the cookie “xpip” set. Therefore, this entry will not stop. Instead, the VNS redirects the browser to the target URL.

The redirection above and “Continue” in steps are performed done to the relative paths which preserves the original host domain name that user came to first. This allows different domains to be saved as the bookmark, based on the vendor which provided the initial entry link for the “Clear Cookie” step above. Such facility could be useful in providing vendor specific bookmarking link on one of their webpages.

Now, by clicking on a single bookmark (x.pip.co), users are automatically and quickly connected to the website page servicing that location. The served website can be used to, for example, view a store or mall directory, search a store inventory, find a location of a product in a given store, view specials of the day, down load coupon images for use at check out, view restaurant menus, make reservations, and even place orders. From the perspective of the registrant, content management is enabled at the local or corporate level and the registration process is fairly straight forward using any personal computer or smart phone connected to the hot spot. If IP changes occur or ISPs are changed, reregistration is also straight forward. Since virtual network server 10, FIGS. 1 and 3 serves as a URL redirector, a single server with its mirror back up can service numerous registered sites and many users anywhere in the world in any language for any domain/suffix. Virtual network server 10 is connectable by Wi-Fi hotspots with interne connectivity providing functions including licensing information, redirection to the actual web and registration servers, records support, and the like. If the device is connected to a particular Wi-Fi hotspot and makes a request to the reserve domain name pretext http://x.pip.co, virtual network server 10 searches database 18 for the IP and subnet and immediately redirects the URL registered in the database connecting the site to the local store page or alternatively to the master web site for the predefined alternative URL if the site is not found. In order to avoid browser caching, the redirection of x.pip.co causing the browser to go to the previous URL after joining a new hotspot, virtual network server 10 performs a double redirection.

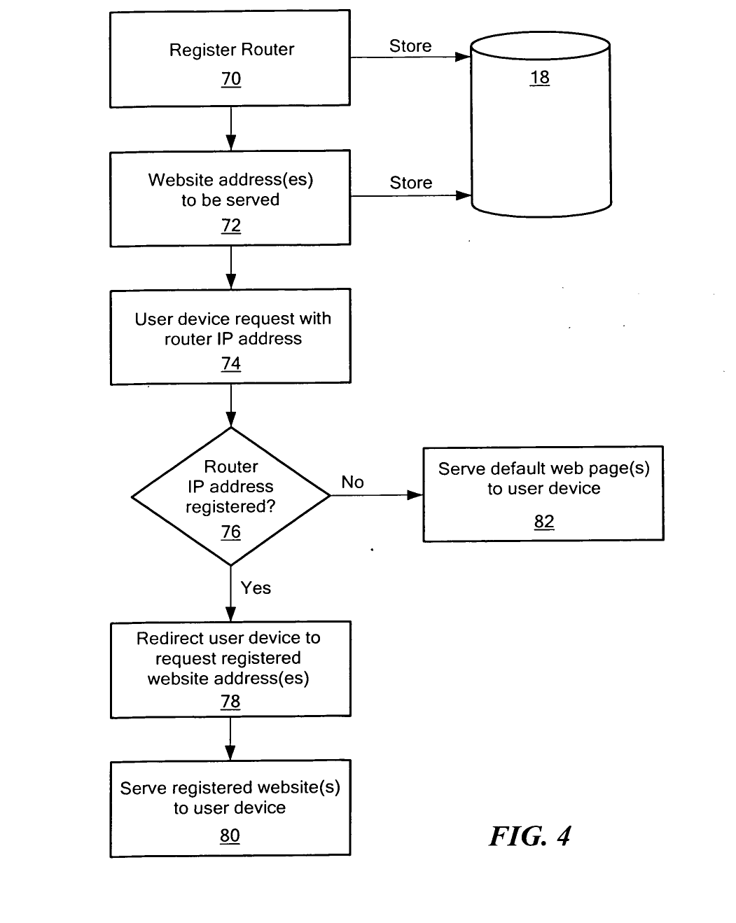

FIG. 4 depicts how a router IP address is registered in database 18, step 70. At least one web site address, step 72 is associated with that router address and also stored in data base 18. A user device then requests a domain name via the router, step 74. In the example used so far, the user device hits the bookmark for x.pip.co. If the router address received at the virtual network server is registered as shown in step 76, the user is redirected to the registered website address or addresses, step 78 and served with the registrant's desired web pages, step 80. If the router IP address is not received not registered at step 76, a default web page or pages can be served to the user, step 82.

Although specific features of the invention are shown in some drawings and not in others, this is for convenience only as each feature may be combined with any or all of the other features in accordance with the invention. The words “including”, “comprising”, “having”, and “with” as used herein are to be interpreted broadly and comprehensively and are not limited to any physical interconnection. Moreover, any embodiments disclosed in the subject application are not to be taken as the only possible embodiments.

In addition, any amendment presented during the prosecution of the patent application for this patent is not a disclaimer of any claim element presented in the application as filed: those skilled in the art cannot reasonably be expected to draft a claim that would literally encompass all possible equivalents, many equivalents will be unforeseeable at the time of the amendment and are beyond a fair interpretation of what is to be surrendered (if anything), the rationale underlying the amendment may bear no more than a tangential relation to many equivalents, and/or there are many other reasons the applicant can not be expected to describe certain insubstantial substitutes for any claim element amended.

Other embodiments will occur to those skilled in the art and are within the following claims.

What is claimed is:

1. A method of directing network traffic comprising:
registering a router IP address and associating it with at least one website address;
at a user device, requesting a domain name via the router;
directing the request to a virtual network server configured to ascertain the website address associated with the router IP address;
redirecting the user device to request the website address; and
serving the user device one or more web pages associated with the website address.

2. The method of claim 1 in which directing the request includes directing the request to a domain name server of the virtual network server.

3. The method of claim 2 in which redirecting the user device includes first redirecting the user device to a web server of the virtual network server configured to receive a web request and then redirecting the user device to request the website address to prevent caching.

4. The method of claim 1 further including the step of serving the user device one or more default web pages if there is no website address associated with the router IP address.

5. The method of claim 1 further including bookmarking, on the user device, the domain name or host.domain name.

6. A method directing network traffic comprising:
registering a router external IP address and associating it with at least one web site address;
directing a pre-established user device request via the router to a virtual network server configured to ascertain the web site address associated with the router IP address; and
automatically redirecting the user device to request the website address to serve the user device one or more web pages associated with the web site address.

7. The method of claim 6 further including serving the user device one or more web pages associated with the web site address.

8. The method of claim 6 in which directing the request includes directing the request to a domain name server of the virtual network server.

9. The method of claim 8 in which redirecting the user device includes first redirecting the user device to a web server of the virtual network server configured to receive a web request and then redirecting the user device to request the website address to prevent caching.

10. The method of claim 6 further including the step of serving the user device one or more default web pages if there is no registered web site associated with the router IP address.

11. The method of claim 6 further including bookmarking, on the user device, the pre-established request.

12. A network traffic redirection system comprising:
a virtual network server including a registration website configured to allow a registrant to register at least one website address associated with a router IP address, the virtual network server further including:
a web server, and
a domain name server configured to automatically receive a pre-established domain name request from a user device connected to the router and configured to redirect the user device request to the web server, and
the web server configured to: automatically receive the redirected user device request and redirect the user device request to the registered web site.

13. The system of claim 12 in which the registration website is further configured to allow a user to bookmark the pre-established domain name on the user device.

14. A network traffic redirecting system comprising:
a registration site configured to register a router IP address and to associate it with at least one website address;
a user device configured to request a domain name via the router; and
a virtual network server configured to:
ascertain the website address associated with the router website IP address, and
redirect the user device to request the website address to serve the user device one or more web pages associated with the web site address.

15. The system of claim 14 in which the virtual network server includes a domain name server configured to receive the user device request.

16. The system of claim 15 in which the domain name server is further configured to redirect the user device request to a web server.

17. The system of claim 16 in which the virtual network server further includes said web server and it is configured to receive the web server request and to redirect the user device to request the web site address to prevent caching.

18. The system of claim 14 in which the virtual network server is further configured to serve the user device one of more default web pages if there is no web site address associated with the router IP address.

19. The system of claim 14 in which the virtual network server is further configured to bookmark the domain name on the user device.
